(19) United States
(12) Patent Application Publication
(10) Pub. No.: US 2014/0214189 A1
(43) Pub. Date: Jul. 31, 2014

(54) WIRELESS DJ CONTROLLER WITH ACCELEROMETERS

(71) Applicant: INMUSIC BRANDS, INC., Cumberland, RI (US)

(72) Inventors: Ross H. GOODWIN, Riverside, RI (US); John Alex SOUPPA, Ashland, MA (US); Christopher ROMAN, Wrentham, MA (US); John E. O'DONNELL, Ft Lauderdale, FL (US)

(73) Assignee: INMUSIC BRANDS, INC., Cumberland, RI (US)

(21) Appl. No.: 13/834,797

(22) Filed: Mar. 15, 2013

Related U.S. Application Data
(60) Provisional application No. 61/758,479, filed on Jan. 30, 2013.

(51) Int. Cl. G06F 3/16

(52) U.S. Cl. CPC G06F 3/165
USPC 700/94

(57) ABSTRACT

A wireless DJ controller includes an accelerometer, a control button, and a wireless transceiver. The wireless DJ controller detects when the control button has been depressed and accesses an output value from the accelerometer. Based on the accessed output value, the DJ controller generates a control signal and transmits the control signal to manipulate an audio signal. Methods of manipulating audio signals using the DJ controller are also disclosed.

### CROSS-REFERENCE TO RELATED APPLICATIONS

This patent application claims priority to Provisional Patent Application No. 61/758,479 filed Jan. 30, 2013, which is herein incorporated by reference in its entirety.

### FIELD OF THE DISCLOSURE

The present disclosure is generally directed toward DJ controllers and more specifically to wireless DJ controllers that include accelerometers.

### BACKGROUND

A disc jockey (“DJ”) is a person who plays audio for an audience. The audio may include prerecorded music tracks, samples, or virtual instruments, for example. Some DJs perform for a live audience by creatively blending one or more tracks of audio and/or manipulating the tracks using effects or transforms. During a performance, the DJ may control when an audio track starts and stops, the levels of the audio tracks being played, or effects that are applied to the audio tracks.

DJs use several pieces of equipment that require control. DJs may use, for example, turntables, hard disk music controllers, computing devices (e.g., laptops, tablet computing devices), or other devices capable of generating an audio signal. DJs may also use devices to enhance his or her own performance, such as lights, lasers or other visual effects. DJs control their equipment through the use of DJ controllers. A DJ controller is typically capable of interfacing with devices that generate audio signals, and DJs manipulate the generated audio signals using the DJ controllers. In some cases, a DJ controller interfaces with software executing on a computing device. For example, a DJ controller may interface with well-known DJ performance software such as Ableton Live™, Traktor Pro 2™, Renoise™, and Akai MPC™.

### SUMMARY

Various embodiments of a DJ controller are disclosed herein. In some embodiments, the DJ controller includes a first accelerometer, a first control button associated with the first accelerometer, a wireless transceiver, and circuitry. The circuitry may be configured to detect when the first control button has been depressed, access a first acceleration output value from the first accelerometer, and generate a first control signal based at least in part on the first accelerometer output value. The generated first control signal is capable of manipulating an audio signal. The circuitry is further configured to cause the wireless transceiver to transmit the generated control signal.

The DJ controller may also include, in some embodiments, a second accelerometer and a second control button associated with the second accelerometer. The circuitry may be further configured to detect when the second control button has been depressed, access a second accelerometer output value from the second accelerometer, generate a second control signal based at least in part on the second accelerometer output value, and cause the wireless transceiver to transmit the generated second control signal. The second control signal is configured to manipulate the audio signal in a manner that is different from the manner in which the first control signal manipulates the audio signal.

In additional embodiments of the DJ controller, the wireless transceiver may be configured to wirelessly receive status signals. The control buttons may include illumination elements, and the circuitry may be configured to illuminate the illumination elements of the control buttons based on the status signals received by the wireless transceiver. In some embodiments, the DJ controller includes a parameter knob and one or more knob assignment buttons. The circuitry may be configured to generate a control signal capable of manipulating an audio signal, wherein the control signal is based on the position of the parameter knob, and whether one of the knob assignment buttons has been depressed. The DJ controller may also include a knob ring, and the circuitry may be configured to illuminate the knob ring based on status signals received by the transceiver.

The present disclosure also describes a method for manipulating an audio signal. The method includes detecting when a first control button of a DJ controller has been depressed, accessing a first accelerometer output value from a first accelerometer of the DJ controller, generating a first control signal based at least in part on the first accelerometer output value, and transmitting the generated first control signal. The first control signal is configured to manipulate an audio signal.

In some embodiments, the method may also include detecting when a second control button of the DJ controller has been depressed, accessing a second accelerometer output value from a second accelerometer of the DJ controller, generating a second control signal based at least in part on the second accelerometer output value, and transmitting the generated second control signal. The second control signal is configured to manipulate the audio signal in a manner that is different than the manner in which the first control signal manipulates the audio signal.

Additional advantages of the DJ controller are set forth in the description which follows; these advantages may be obvious from the description, or may be learned by practicing various aspects of the DJ controller as disclosed herein. It is to be understood that both the foregoing general description and the following detailed description are exemplary and explanatory only. The accompanying drawings, which are incorporated in and constitute a part of this disclosure, illustrate several embodiments of the DJ controller and together with the description, serve to explain the principles of the DJ controller.

### BRIEF DESCRIPTION OF THE DRAWINGS

FIG. 1 is an illustration of one embodiment of a DJ controller.

FIG. 2 is an illustration of a block diagram of a DJ controller according to one embodiment.

FIG. 3 is an illustration of one embodiment of a DJ operating the DJ controller during a performance according to one embodiment.

FIG. 4 is a flow chart illustrating a method for controlling an audio signal using the DJ controller according to one embodiment.

### DESCRIPTION OF THE EMBODIMENTS

Reference will now be made in detail to the exemplary embodiments of the DJ controller, examples of which are illustrated in the accompanying drawings. Wherever possible, the same reference numbers will be used throughout the drawings to refer to the same or like parts.

During a live performance, the DJ needs to control audio playback of tracks and samples. For example, the DJ may start or stop the tracks and samples. The DJ may also control the character of tracks and samples through the use of audio effects or audio transforms such as equalization.

One problem with most DJ controllers is that they are typically wired to the DJ's equipment, which may include computers, turntables, mixers, and the like. As a result, DJs are tethered to their equipment. Many current DJ controllers are large, heavy, and difficult to handle. For DJs that prefer to perform with energy and interact with the audience, their creative expression may be inhibited because they cannot move freely about the stage or among the audience using typical DJ controllers.

Embodiments of the DJ controller disclosed herein solve these problems by offering portable and wirelessly controlled DJ equipment. The DJ controller disclosed herein is handheld and wirelessly capable. It provides a plurality of buttons, triggers, and other controls that advantageously provide the DJ the ability to control and manipulate audio without being restricted by cables. As a result, DJs using the DJ controller may move freely and interact with their audiences in more expressive ways.

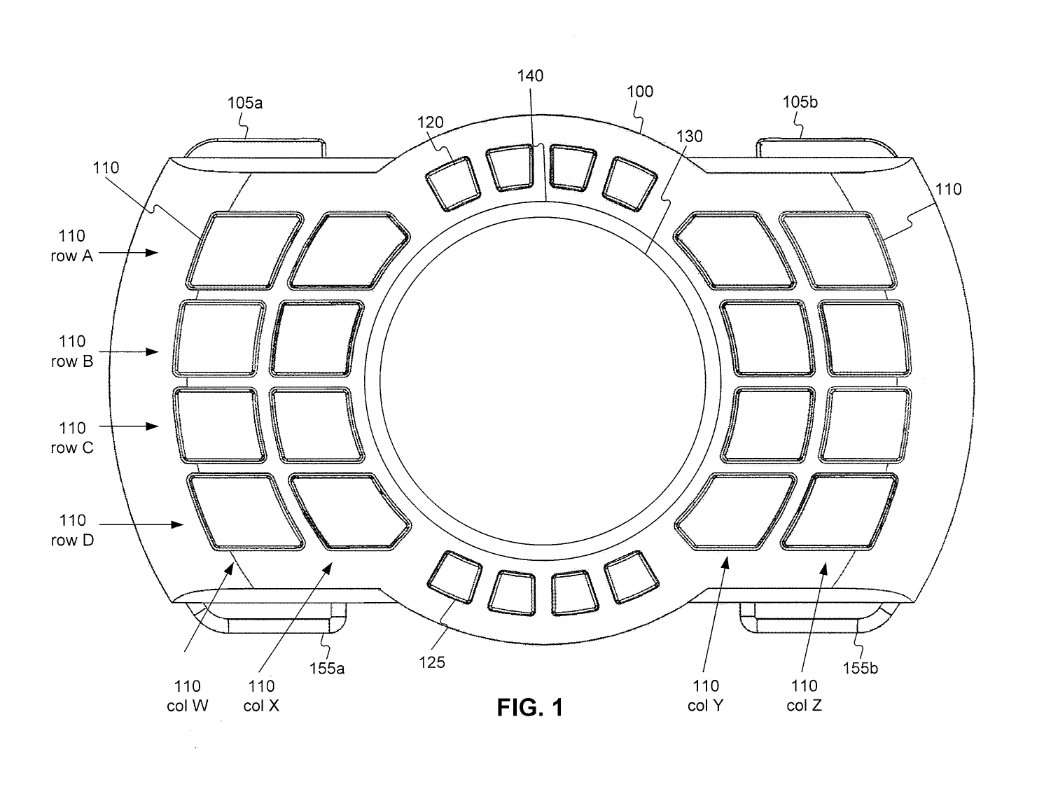

According to one embodiment, the DJ controller 100 depicted in FIG. 1 wirelessly transmits control signals that can be used to manipulate audio signals or samples. The control signals may be processed by DJ performance software or a digital audio workstation (DAW). For example, the control signals may be Musical Instrument Digital Interface (MIDI) signals or may be mappable to MIDI signals. In some embodiments, the DJ controller 100 may communicate with an adapter that wirelessly receives control signals from the DJ controller and outputs signals for consumption by standard DJ performance software or DAWs. The adapter may be, for example, a USB dongle that interfaces with a computer running DJ software through the computer's USB port.

The DJ controller 100 includes accelerometers. The DJ may use the accelerometers to change the parameters of an effect that is applied to an audio signal or sample by moving the DJ controller 100 through space. For example, a DJ may be using the DJ controller 100 to control a phaser that is applied to audio. When the DJ moves the DJ controller up and down, the speed parameter of the phaser may be manipulated, or when the DJ moves the DJ controller left and right the depth parameter of the phaser may be manipulated. The DJ controller 100 may include one or more accelerometers that, when used together, are capable of detecting motion in multiple axes. As used herein, the term “accelerometer” may apply to multiple physical accelerometers, or the term “accelerometers” may apply to one physical accelerometer. For example, reference to an “X-axis accelerometer” and a “Y-axis accelerometer” may refer to one two-axis accelerometer that is capable of detecting motion in the X-axis and the Y-axis. Accordingly, those with skill in the art will appreciate that the DJ controller 100 may include one accelerometer, or a plurality of accelerometers, to achieve the motion detection functionality described herein.

FIG. 1 is an illustration of one embodiment of a DJ controller. The DJ controller 100 includes several control buttons and features that may be used by the DJ to command equipment. For example, the DJ controller 100 includes shoulder buttons 105a-105b, trigger pads 110, knob selector buttons 120, bank selection buttons 125, and knob 130. The DJ controller 100 also includes a lighted knob ring 140 for providing feedback to the DJ while she is using the DJ controller 100. The DJ controller 100 may also include brackets 155a-155b that the DJ can use to attach the DJ controller 100 to a lanyard, armband, or strap.

The shoulder buttons 105a-105b may be used to generate control signals corresponding to motion detected by the accelerometers of the DJ controller 100. For example, the left shoulder button 105a may correspond to the X-axis accelerometer of the DJ controller and the right shoulder button 105b may correspond to the Y-axis accelerometer, or vise-versa. Some embodiments of the DJ controller include a three axis accelerometer, or an accelerometer for each of the X-axis, the Y-axis, and the Z-axis. In such embodiments, the shoulder buttons may be used to send control signals corresponding to the motion detected by the Z-axis accelerometer by pressing both shoulder buttons simultaneously.

When a shoulder button is depressed, the DJ controller sends a control signal corresponding to the motion detected by the shoulder button's associated accelerometer. For example, suppose the left shoulder button 105a is associated with the X-axis accelerometer. When the left shoulder button 105a is pressed, the DJ controller 100 sends a control signal corresponding with the motion detected by the X-axis accelerometer. Also, when the right shoulder button 105b is pressed, the DJ controller sends a control signal corresponding with the motion detected by the Y-axis accelerometer. When both shoulder buttons are pressed, the DJ controller sends a control signal corresponding with the motion detected by the Z-axis accelerometer. In some embodiments, the DJ controller may also include a third shoulder button that may be located on either the left or right side of the DJ controller. When the third shoulder button is pressed, the DJ controller may send a control signal corresponding with the motion detected by the Z-axis accelerometer.

In some embodiments, the shoulder buttons 105a-105b act as momentary switches, that is, the change in motion detected by the accelerometer is applied to the control signals used to change a parameter of an effect while the shoulder buttons 105a-105b are depressed, but not when they are not depressed. The shoulder buttons 105a-105b may also be non-momentary when double tapped. For example, if the DJ is manipulating the level of an audio track using the accelerometers, she may tap one of the shoulder buttons twice to “lock” controlling the level through the use of motion detected by the accelerometers. The lock may be released by tapping the shoulder button again. For example, when the DJ double taps the right shoulder button 105b to lock control of an effect using the accelerometer associated with the right shoulder button 105b, the DJ would need to tap the right shoulder button 105b again to “unlock” the motion control. The right shoulder button 105b will thereafter return to momentary operation until it is double tapped again.

The DJ controller 100 may also include a plurality of trigger pads 110. According to some embodiments, the trigger pads 110 may be configured to send a control signal corresponding to a MIDI signal. By default, the trigger pads 110 may be configured to send a momentary signal. However, the trigger pads 110 may be configured to act as a non-momentary switch in some embodiments. The trigger pads 110 may also be mapped to any controllable effect available in the DJ software. For example, the trigger pads 110 may be mapped to a sample, delay, reverb, flanger, phaser, comb filter, or some other effect. The trigger pads 110 may also be mapped to a MIDI enabled synthesizer and each trigger pad may be used to produce a tone using the settings of the synthesizer.

A DJ may use the trigger pads 110 in combination with the shoulder buttons 105a-105b to apply an effect to an audio signal, and to modify the parameters of the effect. For example, a DJ may press one of the trigger pads 110 to select an effect that controls the speed of an audio track. As the DJ holds the trigger pad for the speed effect, the DJ may also press and hold the left shoulder button 105b activating the accelerometer associated with the X-axis. The DJ may then control the speed of the audio by tilting the DJ controller in the X direction.

According to some embodiments, the trigger pads 110 may include illumination elements. The illumination elements illuminate the trigger pads 110. For example, the trigger pads 110 may include multicolored LEDs. The trigger pads 110 may illuminate in response to being touched. For example, when a DJ depresses a trigger pad, it may illuminate green, and when the trigger pad is released, it may no longer be illuminated.

The trigger pads 110 may also illuminate when the shoulder buttons are depressed to reflect motion detected by the accelerometers. The trigger pads may not illuminate when the DJ controller is in a “neutral” position, that is, when the accelerometers do not detect tilt or motion. The trigger pads may illuminate a first color when the accelerometers detect tilt or motion in the X-axis, and may illuminate a second color when the accelerometers detect tilt or motion in the Y-axis. The trigger pads may illuminate by row or column depending on the degree of tilt. For example, when the DJ presses the left shoulder button 105a and tilts the DJ controller slightly up, the trigger pads in the second row (110 row B) may illuminate green. As the DJ continues to tilt the DJ controller 100 up, the first row (110 row A) may also illuminate green. When the DJ moves the controller back to the neutral position, the trigger pads 110 may no longer illuminate. Further, when the DJ presses the right shoulder button 105b and tilts the DJ controller slightly to the right, the third column of trigger pads (110 col Y) may illuminate orange. As the DJ continues to tilt the DJ controller 100 to the right, the fourth column of trigger pads (110 col Z) may also illuminate orange. When the DJ moves the DJ controller 100 back to the neutral position, the trigger pads may no longer illuminate.

In some embodiments, the trigger pads 110 may illuminate in response to status signals received by the DJ controller 100. The DJ controller 100 may receive status signals indicating the status of an effect. For example, a DJ may be using the DJ controller to modify the parameters of a software-based flanger, and the right shoulder button 105b (and its associated accelerometer) may correspond to the depth parameter of the flanger. The DJ may press the right shoulder button 105b to begin modifying the flanger. As the DJ tilts the DJ controller, control signals may be sent to the software-based flanger to modify the depth parameter. The DJ controller may thereafter receive status signals from the flanger reflecting the current value of the depth parameter, and the trigger pads 110 may illuminate in response to the received signals. For example, as the DJ controller 100 receives status signals reflecting an increase in depth, more trigger pads may illuminate, and as the DJ controller 100 receives status signals reflecting a decrease in depth, trigger pads may lose illumination.

DJs may also custom-set colors for the trigger pads 110. The colors may be set using a color setting mode that the DJ controller enters when the DJ presses the control buttons using a predefined pattern. For example, the DJ controller 100 may enter a color-setting mode when a DJ presses a bank selection button 125 while simultaneously pressing one of the shoulder buttons 105a-105b. The knob selector buttons 120 may flash on and off to indicate that the DJ controller 100 has entered the color-setting mode. The trigger pads 110 may illuminate with their currently assigned color. The DJ may then choose a color-selection group by pressing the trigger pads 110 for which he is setting or changing the color, and the trigger pads 110 may blink in response. The DJ may then also scroll through the available colors using the shoulder buttons 105a-105b. The DJ may remove a selected trigger pad 110 (indicated by the particular trigger pad blinking) from the color selection group by selecting it again. The DJ may then exit colors-selection mode by pressing one of the bank selection buttons 125.

The DJ controller 100 offers multiple sets of trigger pad configurations through the use of banks. A “bank” is a set of effects assigned to trigger pads that are available to the DJ simultaneously. For example, in the embodiment shown in FIG. 1, the DJ controller 100 has sixteen trigger pads. A bank would be the set of effects assigned to the sixteen trigger pads. The DJ can change banks using the bank-selection buttons 125. When the DJ selects one of the banks, the trigger pads 110 may change configuration and offer different effects. As a result, the DJ controller 100 can control more effects and triggers than the number of trigger pads it has. For example, in the embodiment of FIG. 1, the DJ controller has sixteen trigger pads and four banks for a total of sixty-four possible effects that can be controlled using the DJ controller.

In some embodiments, the DJ controller 100 includes a knob 130. The knob 130 may be used to control the parameters of an effect, equalization, or the level of an audio track. The knob 130 may have four different functions in each bank. The four functions are selectable using the knob-selector buttons 120. As the knob-selector buttons change the function of the knob 130 for each bank, the DJ controller makes available to the DJ more virtual knobs than knob 130 and knob-selector buttons 120. For example, as shown in FIG. 1, the DJ controller may have four knob selector buttons 120 and four bank selection buttons 125 for a total of sixteen virtual knobs.

In some embodiments, the knob 130 may be surrounded by a knob ring 140. The knob ring 140 may include a “lightpipe” of several LEDs placed around the knob that switch on to illuminate it. The knob ring 140 may illuminate to provide feedback to the DJ by showing the DJ the current setting of the effect the knob currently controls. For example, in some embodiments, the knob ring 140 illuminates based on status signals received by the DJ controller 100. In such embodiments, the knob 130 may be used to control the level of an audio track. The DJ controller 100 may receive a status signal indicating that the current level of the audio track is 50% of the max level. In response, 50% of the knob ring may illuminate, i.e., the left half of the knob ring may illuminate.

In various embodiments, the knob 130 may operate in an absolute mode or a relative mode. In absolute mode, the knob ring 140 may show the current value of the parameter associated with the knob (e.g. 50% of the ring illuminates when the parameter is at 50% of its max value). In relative mode, every other LED of the knob ring 140 may illuminate and may appear to rotate with the knob 130. For example, in relative mode every odd numbered LED (e.g., first, third, fifth, etc.) may illuminate, and as the knob is turned, the even numbered LEDs (e.g., second, fourth, sixth, etc.) and the odd numbered LEDs may alternate in illumination to simulate rotation of the knob 130.

The DJ controller 100 may also include brackets 155a-155b. The brackets 155a-155b may be used to attach the DJ controller 100 to the DJ using, for example, a lanyard, belt, armband, or strap. The brackets 155a-155b may be made of plastic or metal, and are of suitable construction to support the weight of the DJ controller.

In some embodiments, the DJ controller 100 may include a rechargeable battery. The rechargeable battery may be a lithium/ion battery. When the battery charge is low, one of the buttons may flash indicating that the battery will need to be recharged. For example, the bank selection button corresponding to the currently selected bank may flash when the battery charge is low.

The DJ controller 100 may also include a USB port. The USB port may be used to recharge the battery, or it may be used to connect the DJ controller 100 to DJ software or DAWs, thereby allowing wired operation. In some embodiments, the DJ controller 100 may be configured using the wired connection. For example, the trigger pads 110 may be mapped to effects using the wired connection. The wired connection may also be used to control effects or audio in a manner consistent with wireless operation.

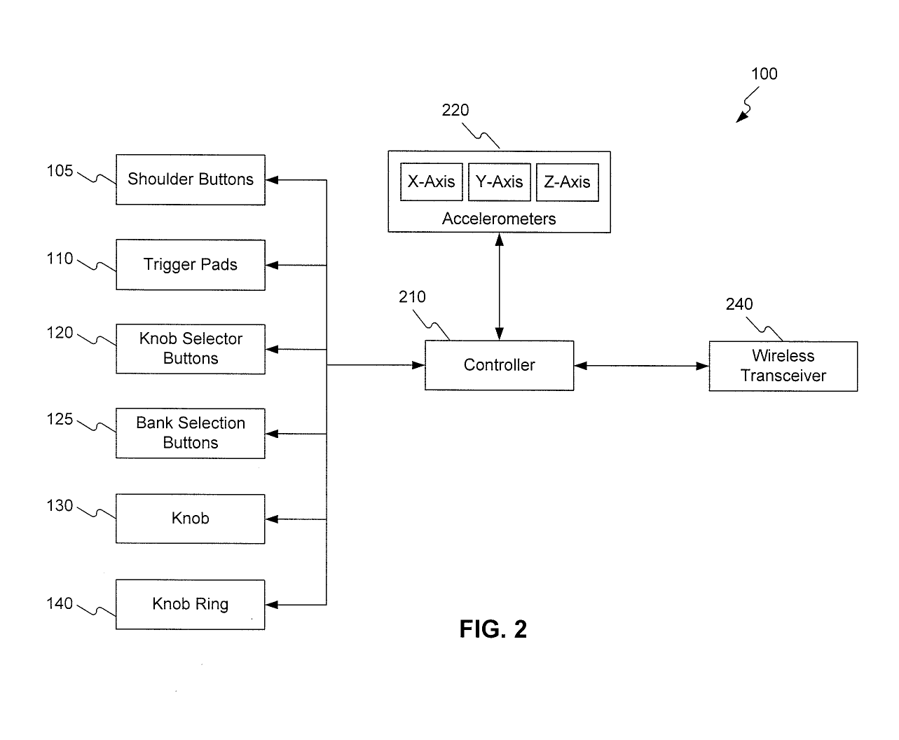

FIG. 2 is an illustration of a block diagram of the DJ controller 100 according to one embodiment. The DJ controller 100 may include input and output controls such as shoulder buttons 105, trigger pads 110, knob selector buttons 120, bank selector buttons 125, a knob 130, and a knob ring 140. These input and output controls of the DJ controller 100 may function in substantially the same manner as described with respect to FIG. 1. The input and output controls may be connected to the controller 210, and they may send electronic or digital signals to the controller 210, and the controller 210 may send electronic or digital signals to the controls. For example, when a shoulder button 105 is depressed, it may generate an electronic signal that is sent to the controller 210 indicating that the button has been depressed. By way of further example, the controller 210 may send an electronic signal to one of the trigger pads 110 to illuminate the illumination elements of the trigger pads 110. The input and output controls may be hard-wired to a circuit board or wired directly to the controller 210. When a DJ manipulates one of the input or output controls, they may contact the circuit board, thereby closing a circuit. When the circuit is closed, an electronic signal or pulse may be sent to the controller 210 indicating that the DJ has depressed the input or output controls.

In some embodiments, the input and output controls may be embodied as software modules that interface with the controller 210. The software modules may generate and receive digital signals to and from the controller 210. The input and output controls may be embodied as software modules, for example, when the DJ controller is embodied as a software application for execution on a tablet or mobile device with a touchscreen; when the DJ selects a user interface corresponding to one of the controls by tapping the touchscreen, a software module supporting the control may generate a signal that can be consumed by the controller 210.

In general, the word module, as used herein, refers to logic embodied in hardware or firmware, or to a collection of software instructions, possibly having entry and exit points, written in a programming language, such as C, C++, C#, Java or assembly language. A software module may be compiled and linked into an executable program, installed in a dynamic link library, or may be written in an interpreted programming language such as, BASIC, Perl, or Python. It will be appreciated that software modules may be callable from other modules or from themselves, and/or may be invoked in response to detected events or interrupts. Software modules may be stored in any type of computer-readable medium, such as a memory device (e.g., random access, flash memory, and the like), an optical medium (e.g., a CD, DVD, BluRay®, and the like), firmware (e.g., an EPROM), or any other storage medium. The software modules may be configured for execution by one or more CPUs in order to cause the DJ controller 100 to perform particular operations. Modules may also be embodied as hardware and may be comprised of connected logic units, such as gates and flip-flops, and/or may be comprised of programmable units, such as programmable gate arrays or processors, for example. Generally, the term module refers to a logical unit that may be combined with other modules or divided into sub-modules according to each embodiment.

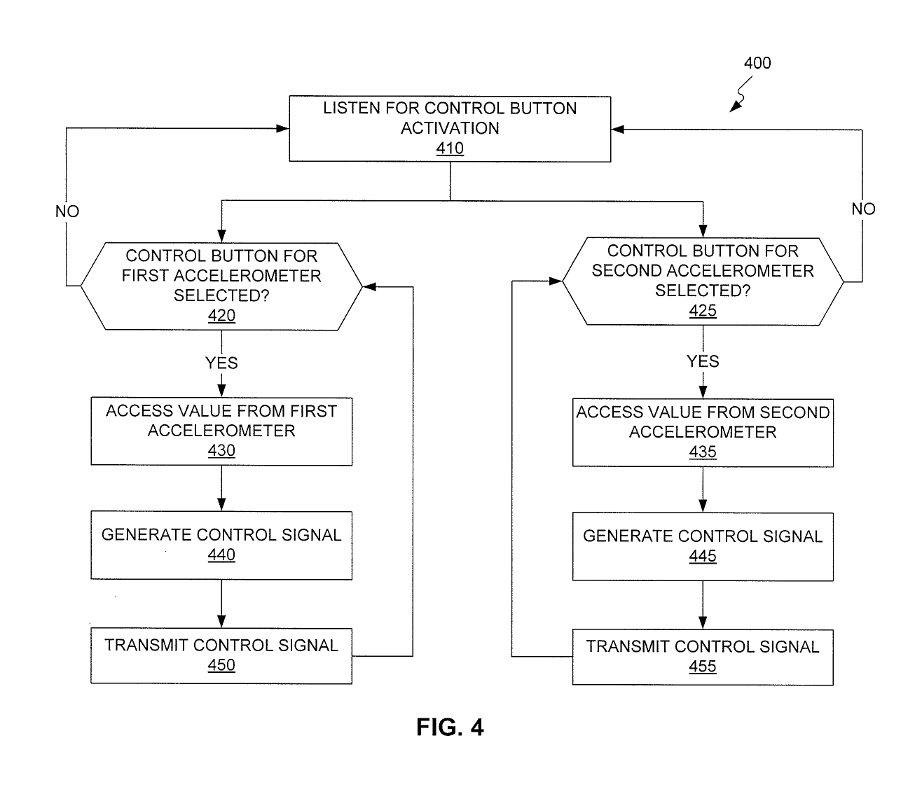

In addition to shoulder buttons 105, trigger pads 110, knob selector buttons 120, bank selector buttons 125, knob 130 and knob ring 140, the controller 210 may be embodied as a software module, stored in a computer readable medium and executable by a processor, or in other embodiments, may be embodied as hardware or firmware. The controller 210 controls the operations of the DJ controller by determining, for example, when the input and output controls are being manipulated, generating appropriate control signals in response, and commanding the wireless transceiver 240 to transmit the control signals. The controller 210 may, for example, perform the functionality depicted in the flow chart of FIG. 4.

In some embodiments, the controller 210 accesses output values from the accelerometers 220 to generate control signals. The controller 210 may access the output values while one of the control buttons, such as the shoulder buttons 105 or trigger pads 110, is depressed by the DJ. Based on the output values accessed from the accelerometers 220, the controller 210 generates the appropriate control signals and commands the wireless transceiver 240 to transmit the control signals.

The accelerometers 220 may be three separate accelerometers for detecting motion along the X-axis, Y-axis, and Z-axis, or it may be one accelerometer capable of detecting motion along all three axes (e.g., a three-axis accelerometer). The accelerometers 220 may be analog, that is, they may output a continuous voltage that is proportional to the acceleration detected. In other embodiments, the accelerometers 220 may be digital, that is, they may use pulse width modulation (PWM) for output and the amount of time the voltage is high will be proportional to the amount of acceleration. One with skill in the art will understand that the type of accelerometers 220 used may be determined based on design choices such as whether the controller 210 is a software module, or a hardware/firmware module, and/or based on various cost and manufacturing concerns.

While FIG. 2 describes certain modules that may be part of the DJ controller 100, one with skill in the art will understand that a DJ controller 100 may include more or less modules depending on a particular application, and such inclusion of more or less modules will not alter the spirit and scope of the present disclosure.

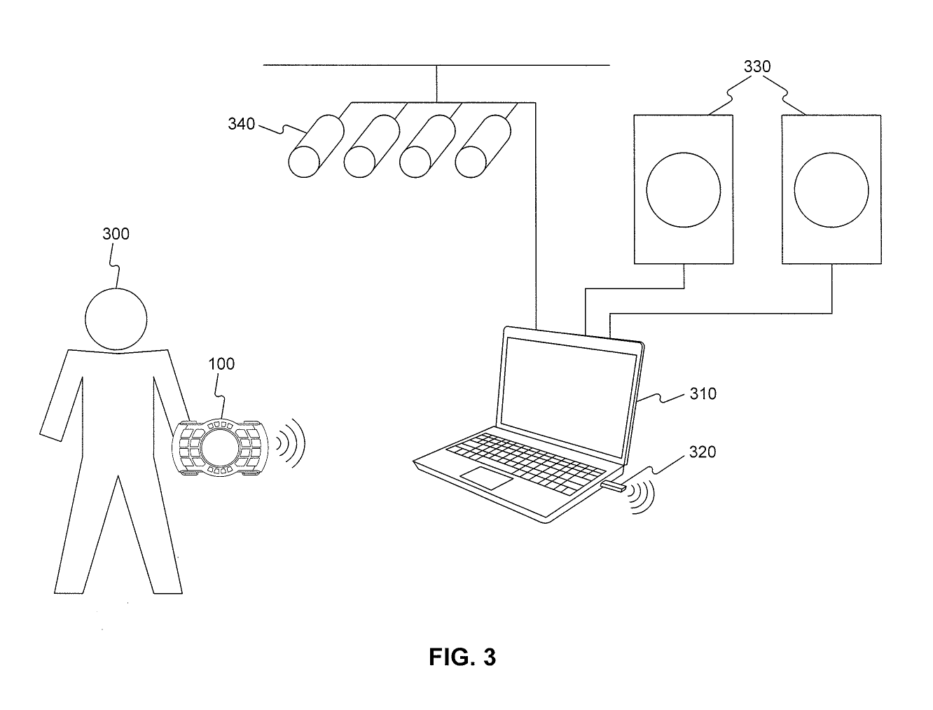

FIG. 3 is an illustration of one embodiment of a DJ 300 operating the DJ controller 100 during a performance. In this embodiment, the DJ controller 100 is controlling software executing on laptop 310. The laptop 310 is controlling audio that is output through the speakers 330, and the laptop 310 is controlling the lights 340. In the embodiment of FIG. 3, the DJ 300 uses the DJ controller 100 to control the operation of the audio and the lights 340 through a wireless connection to a USB dongle 320.

The USB dongle 320 may include a LED indicator. The LED indicator may illuminate when a connection is made to the DJ Controller 100. For example, the LED indicator may illuminate when the DJ Controller 100 is powered on and a connection is established between the DJ Controller 100 and the USB dongle 320.

The DJ controller 100 and the USB dongle 320 could be “paired” to effectively communicate with each other. Pairing may be accomplished through the use of specialized frequencies, identification packets, or any other method of pairing wireless devices known by those with skill in the art. Although pairing is generally set at the factory before the DJ controller 100 and the USB dongle 320 are delivered to the DJ 200, the DJ controller 100 and the USB dongle 320 may be paired manually. A DJ 300 may pair a DJ controller 100 to a USB dongle 320 by pressing the control buttons in a predetermined pattern. For example, the DJ may press a first trigger pad while powering on the DJ controller 100. In response, one of the knob selection buttons may flash indicating to the DJ that the DJ controller 100 is entering a pairing mode. The DJ may then connect the USB dongle 320 to a USB port on the DJ controller 100, and the DJ may press a second trigger pad to command the DJ controller 100 to pair with the connected USB dongle 320. If the pairing is successful, the LED indicator on the USB dongle may flash indicating a successful pairing. If the pairing is unsuccessful, the LED indicator will not flash. Control buttons of the DJ controller 100 may also flash upon a successful or unsuccessful pairing. According to some embodiments, multiple DJ controllers may be paired with one USB dongle 320. For example, a first DJ controller may be paired with the USB dongle 320 to control one group of effects, while a second DJ controller may be paired with the USB dongle 320 to control a second group of effects. In such embodiments, both DJ controllers may be paired using the technique described above.

In some embodiments, the DJ controller 100 and the USB dongle 320 communicate using a low latency 2.4 GHz connection. A low latency wireless connection is desired so that changes to the audio signals produced by laptop 310 or to the lights 340 are reflected in near real time. As the DJ 300 operates the DJ controller 100, the DJ controller 100 sends control signals or MIDI signals to the USB dongle 320. The USB dongle 320 then passes the control signals to the appropriate software executing on the laptop 310. In some embodiments, the USB dongle 320 may interface with multiple applications. For example, in the embodiment of FIG. 2, the USB dongle 320 interfaces with DJ performance software and with a lighting controller that controls the lights 340. Thus, the DJ controller 100 can make changes to the audio or the lights to enhance the DJ 300's live performance.

FIG. 4 is a flow chart illustrating a method 400 for controlling an audio signal using the DJ controller 100 according to one embodiment. The method 400 illustrates the processing steps that may be performed by DJ controller 100 to control an audio signal using output values obtained from the accelerometers 220. As described above, the DJ controller 100 may obtain the output values from the accelerometers 220 in response to a control button being selected, that is, the control button may act as a switch that allows the manipulation of an audio signal based on the tilt or motion of the DJ controller while selected, but may not use the tilt or motion of the DJ controller to manipulate the audio signal while the control button is not selected. The method 400 may be performed by controller 210 or some other module of the DJ controller 100. Depending on the embodiment, the method may include fewer or additional steps and/or the steps may be performed in a different order than is illustrated.

Method 400 beings with step 410. At step 410, the DJ controller 100 listens for the activation of one or more control buttons. The control buttons may be, for example, one of the shoulder buttons 105 or one of the trigger pads. In some embodiments, the DJ controller 100 may listen for multiple button activations and generate appropriate control signals in parallel. Once the DJ controller 100 determines that a control button has been activated, processing moves to step 420 and step 425. If the activated control button is associated with the first accelerometer (step 420: YES), processing moves to step 430. If the activated control button is associated with the second accelerometer (step 425: YES), processing moves to step 435. If the activated control button does not correspond to any accelerometer (steps 420, 425: NO), processing returns to step 410.

At step 430, the DJ controller accesses the output value of the first accelerometer in response to the control button for the first accelerometer being selected. The accessed output value is used to generate the control signal at step 440, which is then transmitted at step 450 to DJ equipment such as a laptop (as depicted in FIG. 3, for example). At step 435, the DJ controller accesses the output value of the second accelerometer in response to the control button for the second accelerometer being selected. The accessed output value is used to generate the control signal at step 445, which is then transmitted at step 455 to DJ equipment.

Once the control signal is transmitted at step 450 (corresponding with the first accelerometer), processing returns to step 420, where the DJ controller again determines if the control button for the first accelerometer is selected. If not, processing returns to step 410, where the DJ controller listens for control button activation. If the control button for the first accelerometer is still selected, processing moves to step 430. Further, once the control signal is transmitted at step 455 (corresponding with the second accelerometer), processing returns to step 425, where the DJ controller determines if the control button for the second accelerometer is selected.

Other embodiments of the DJ controller will be apparent to those skilled in the art from consideration of the specification and practice of the DJ controller disclosed herein. It is intended that this disclosure and the examples disclosed herein be considered exemplary only.

What is claimed is:

1. A wireless DJ controller comprising:
a first accelerometer,
a first control button associated with the first accelerometer,
a wireless transceiver, and
circuitry configured to:
detect that the first control button has been depressed,
access a first accelerometer output value from the first accelerometer,
generate a first control signal based at least in part on the first accelerometer output value, and
cause the wireless transceiver to transmit the generated first control signal,
wherein the first control signal is configured to manipulate an audio signal.

2. The wireless DJ controller of claim 1, further comprising:
a second accelerometer, and
a second control button associated with the second accelerometer,
wherein the circuitry is further configured to:
detect that the second control button has been depressed,
access a second accelerometer output value from the second accelerometer,
generate a second control signal based at least in part on the second accelerometer output value, and
cause the wireless transceiver to transmit the generated second control signal,
wherein the second control signal is configured to manipulate the audio signal in a manner that is different from the manner in which the first control signal manipulates the audio signal.

3. The wireless DJ controller of claim 1, further comprising a trigger button, wherein the circuitry is further configured to:
detect when the trigger button has been depressed,
generate a second control signal associated with the trigger button, and
cause the wireless transceiver to transmit the generated second control signal, the second control signal being configured to change the parameter of an audio effect.

4. The wireless DJ controller of claim 1, further comprising a plurality of trigger buttons comprising illumination elements, wherein the circuitry is further configured to activate the illumination elements based at least in part on the accessed first accelerometer output value.

5. The wireless DJ controller of claim 1, wherein the circuitry is further configured to:
receive one or more status signals corresponding to a signal state of the audio signal, and
generate feedback based at least in part on the received one or more status signals.

6. The wireless DJ controller of claim 5, further comprising a trigger button comprising an illumination element, wherein the generated feedback includes illuminating the illumination element of the trigger button.

7. The wireless DJ controller of claim 1, further comprising a parameter knob, wherein the circuitry is further configured to:
detect whether the parameter knob has been manipulated, and
generate an effect parameter control signal based at least in part on the manipulation of the parameter knob, the effect parameter control signal being configured to manipulate the audio signal.

8. The wireless DJ controller of claim 7, further comprising:
a first knob-assignment button,
a second knob-assignment button,
wherein the circuitry is further configured to detect whether the first knob-assignment button or the second knob-assignment button is selected, and
wherein the effect parameter control signal corresponds to a first effect parameter when the first knob-assignment button is selected, and corresponds to a second effect parameter when the second knob-assignment button is selected.

9. The wireless DJ controller of claim 7, further comprising an illuminable knob ring.

10. The wireless DJ controller of claim 9, wherein the circuitry is further configured to:
receive status signals corresponding to a signal state of the audio signal, and
illuminate the knob ring based at least in part on the received status signal.

11. A method for manipulating an audio signal, the method comprising:
detecting that a first control button of a DJ controller has been depressed,
accessing a first accelerometer output value from a first accelerometer of the DJ controller,
generating a first control signal based at least in part on the first accelerometer output value, and
transmitting the generated first control signal, wherein the first control signal is configured to manipulate the audio signal.

12. The method of claim 11, further comprising:
detecting that a second control button of the DJ controller has been depressed,
accessing a second accelerometer output value from a second accelerometer of the DJ controller,
generating a second control signal based at least in part on the second accelerometer output value, and
transmitting the generated second control signal, wherein the second control signal is configured to manipulate the audio signal in a manner that is different from the manner in which the first control signal manipulates the audio signal.

13. The method of claim 12, further comprising:
activating one or more illumination elements of trigger buttons of the DJ controller according to a first pattern based at least in part on the accessed first accelerometer output value, and
activating one or more illumination elements of trigger buttons of the DJ controller according to a second pattern based at least in part on the accessed second accelerometer output value.

14. The method of claim 11, further comprising activating the illumination elements of trigger buttons of the DJ controller based at least in part on the accessed first accelerometer output value.

15. The method of claim 11, further comprising:
detecting that a trigger button of the DJ controller has been depressed,
generating a second control signal associated with the trigger button, and
transmitting the generated second control signal, wherein the second control signal is configured to change at least one parameter of an audio effect.

16. The method of claim 11, further comprising:
receiving one or more status signals corresponding to a signal state of the audio signal, and
generating feedback based at least in part on the received one or more status signals.

17. The method of claim 16, wherein the feedback comprises illuminating an illumination element of a trigger button of the DJ controller.

18. The method of claim 11, further comprising:
detecting that a parameter knob of the DJ controller has been manipulated, and
generating an effect parameter control signal based at least in part on the manipulation of the parameter knob,
wherein the effect parameter control signal is configured to manipulate the audio signal.

19. The method of claim 18, further comprising: detecting that a first knob-assignment button of the DJ controller or a second knob-assignment button of the DJ controller is selected, wherein the effect parameter control signal corresponds to a first effect parameter when the first knob-assignment button is selected, and corresponds to a second effect parameter when the second knob-assignment button is selected.

20. The method of claim 11, further comprising:
receiving one or more status signals corresponding to a signal state of the audio signal, and
illuminating a knob ring of the DJ controller based at least in part on the received one or more status signals.
